(19) United States
(12) Patent Application Publication
(10) Pub. No.: US 2008/0195489 A1
(43) Pub. Date: Aug. 14, 2008

(54) Method and system for dynamic update of vehicle lot prices

(76) Inventors: Cory A. Gold, Saint Paul, MN (US); Gary A. Emfield, Plymouth, MN (US)

Correspondence Address: Hoffman, Wasson & Gitler, P.C., 2461 South Clark Street, Suite 522, Arlington, VA, 22202, US

(21) Appl. No.: 12/068,917

(22) Filed: Feb. 13, 2008

Related U.S. Application Data
(60) Provisional application No. 60/900,996, filed on Feb. 13, 2007.

(51) Int. Cl. G06Q 30/00

(52) U.S. Cl. 705/14

(57) ABSTRACT

The system and method allows for the quick and easy update and display of information regarding vehicles in a dealership lot. Since each vehicle is unique in its price, mileage and features, the system allows the information for each vehicle to be stored in a database and transmitted to a display associated with the vehicle.

This application claims benefit of provisional application 60/900,996, filed Feb. 13, 2007.

### BACKGROUND OF THE INVENTION

Decades ago, it was necessary to mark each item in a store with a price label. This meant that even if there were large numbers of the same product, each individual product needed to be marked with the price. This caused the expenditure of a great deal of time to change prices already on the shelves, as an employee had to manually re-price each item. The advent of bar codes and optical readers greatly improved this process. Each product has a bar code that, when scanned, indicated the price in the cash register. By changing the association of the bar code with its price, prices could be updated quickly and easily.

Difficulties arise, however, when the goods to be sold each have a different price and one wishes to update that information quickly. One such scenario is an auto dealership where each car, given the make, model and options, has a different price than every other car on the lot. This is especially true when the pricing information needs to be conveyed to purchasers.

It is an object of the invention to provide for remote updating of pricing in vehicle information in a dealership.

It is another object of the invention to provide a database that directly relates prices of merchandise to a display device.

It is yet another object to provide a computer program reading the database and controlling the display unit to reflect pricing and vehicle information.

It is another object to provide a system for updating the pricing in vehicle information through a wireless link.

These and other objects of the invention will be apparent to one of ordinary skill in the art after reviewing the disclosure of the invention.

### SUMMARY OF THE INVENTION

The system and method allows for the quick and easy update and display of information regarding vehicles in a dealership lot. Since each vehicle is unique in its price, mileage and features, the system allows the information for each vehicle to be stored in a database and transmitted to a display associated with the vehicle.

### BRIEF DESCRIPTION OF THE DRAWINGS

FIG. 1 is a schematic view of the invention;

FIG. 2 is a view of an automobile having display; and

FIG. 3 depicts the interaction of the database and the vehicle lot pricing database.

### DETAILED DESCRIPTION OF THE INVENTION

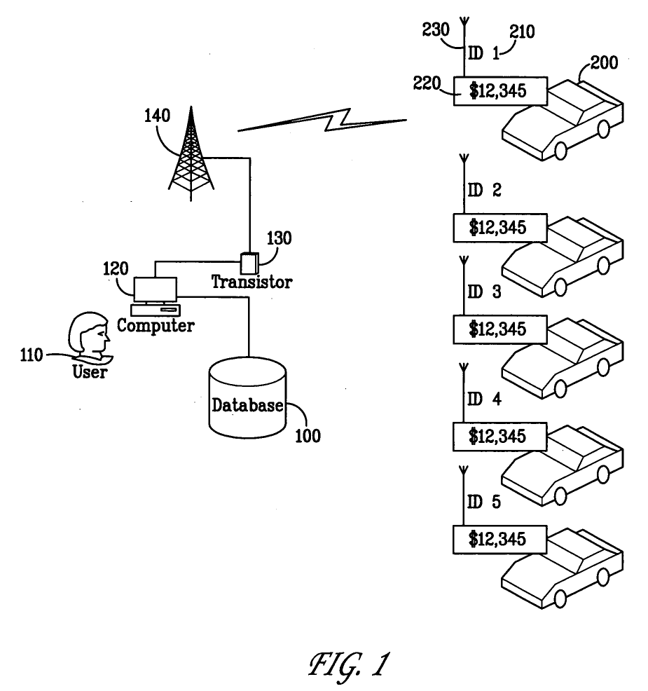

The vehicle lot price update system shown in FIG. 1, consists of a computer 120 connected to a radio transceiver 130 and having access to a database 100 of vehicle pricing information. The transceiver has antennae 140 allowing communication of data to radio receiving units 210. When a price update is received by a dealership, the user 110 makes changes to the prices in the database corresponding to the radio receiving and display units 220. The computer program updates each unique display unit with the correct pricing and any other vehicle information specific to the vehicle that the display unit shows. Other information may include the model name, options and dealership inventory number.

Each vehicle 200 has a unique identification 210 and a radio receiving unit 220. Each unit 220 has antennae 230 allowing data transfer between the unit 220 and computer 120. The link between the computer 120 and each receiver 220 is such that the information sent is verified by each receiver 220. If the receiver detects that it did not receive valid information, a request is sent back to the transmitter to retransmit the information again.

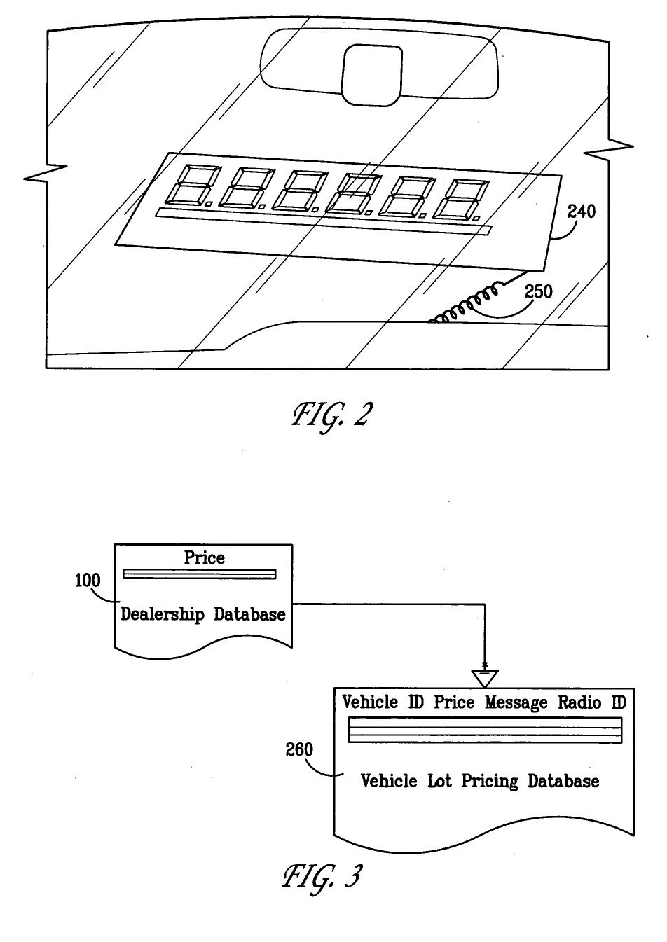

FIG. 2 shows a version of the pricing system using a numeric-only display. The unit 220 is secured to a window such as the windshield with any appropriate connector, such as suction cups 240. The display may be placed in any window and multiple displays may be used in a single vehicle. The units may also be placed outside of the vehicle but then the units must be able to weather. The displays may be powered by internal batteries or have a power connection to an external battery source, such as the car battery, by a power cord 250.

FIG. 3 shows the relationship of a dealerships database 100 with the display in each vehicle. The display stores information such as the vehicle ID, which may be the VIN or another number assigned to the vehicle, the price, a message such as the vehicles mileage and features and the radio ID in a vehicle lot pricing database 260. Whereas the vehicle ID may be changed as the display is moved from one vehicle to the next, the radio ID is a number permanently assigned to the display to distinguish the display from all other displays. Information from the dealership database 100 to the vehicle lot pricing database 260 in any appropriate manner, such as by wireless link.

While the invention has been describes with reference to a preferred embodiment, variations and modifications would be apparent to one of ordinary skill in the art. The invention incorporates such variations and modifications.

What is claimed is:

1. A display system comprising:
a computer, said computer having a database,
a transmitter sending data from the computer,
a receiver receiving data from the computer,
a unit storing data received from the computer, said unit having a display.

2. The display system of claim 1, wherein said transmitter is a wireless transmitter.

3. The display system of claim 1, wherein the display mounted in a vehicle, the display providing information about the vehicle.

4. The display system of claim 3, wherein the information comprises the price.

5. The display system of claim 1, wherein the data comprises the price.

6. The display system of claim 1, further comprising a plurality of receivers, each receiver having a unique identifier to receive data different than other receivers.
